(19) United States
(12) Patent Application Publication
(10) Pub. No.: US 2009/0210924 A1
(43) Pub. Date: Aug. 20, 2009

(54) METHOD AND APPARATUS FOR ADAPTING A CHALLENGE FOR SYSTEM ACCESS

(75) Inventors: Patrick M. Maurer, Wayland, MA (US); George Arthur Harvey, Marlborough, MA (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/033,063

(22) Filed: Feb. 19, 2008

(51) Int. Cl. G06F 21/06

(52) U.S. Cl. 726/2

(57) ABSTRACT

A method and apparatus for accessing a device via an adaptive challenge is provided herein. During operation, the challenging device will determine a user's context. The challenge used to access the system (111) will be adapted to the user's context.

### FIELD OF THE INVENTION

The present invention relates generally to accessing a device requiring an answer to a challenge, and in particular, to a method and apparatus for adapting a challenge for system access.

### BACKGROUND OF THE INVENTION

Computer systems today contain sensitive information and resources that must be protected. In order to access these systems, a user is generally issued a challenge, and must correctly answer the challenge. There exist many issues with having a single challenge for accessing a system. For example, email-capable handsets issued to employees are required to be password-protected with a time-based lockout. Unfortunately, gaining entry to these systems often requires keyboard entry, precluding hands-free operation and potentially making use while moving difficult . . . . Additionally, users will often times have to remember multiple long passwords in order to gain access to computer systems. It would be much more efficient if the user is presented a challenge that was more secure when the user accesses the system via an “unknown” location as opposed to a location with restricted access. Thus, if the user is accessing from a restricted area, there is a much higher likelihood that the challenged user is the authorized user, and a less-secure challenge may be issued. Therefore, a need exists for a method and apparatus for accessing a device via a challenge that takes into consideration a user's context, and adapts the challenge based on the user's context.

### BRIEF DESCRIPTION OF THE DRAWINGS

FIG. 1 is a block diagram of a user environment.

FIG. 2 is a block diagram of a system requiring an answer to a challenge to gain access.

FIG. 3 is a flow chart showing operation of the system of FIG. 2.

FIG. 4 is a flow chart showing operation of the system of FIG. 2.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION OF THE DRAWINGS

In order to alleviate the above-mentioned need, a method and apparatus for accessing a device via an adaptive challenge is provided herein. During operation, the challenging device will determine a user's context. This context may be, for example, a user's location or speed. In response to the user's context, the challenge will be adapted accordingly. Thus, for example, if a user is known to be moving, a challenge may comprise one that is input via a user's voice. Another example is if the challenged device is known by the challenger to be in a specific location with restricted access. This contributes to the likelihood the user of the challenged device is (or is not, if user is not normally allowed there) an authorized user. For example, the probability that the person accessing a mobile device is the authorized user is much higher if the device is known to be in the user's home. It is higher still if the user and device are also known to be at their place of work. Similarly, if the user's headset (such as a Bluetooth headset) is present, this increases the likelihood that the challenged user is the authorized user.

The above approach allows the authorized user to more easily access the device, since, for example they do not have to look at and type on the device if they are moving, or they do not have to input long passwords when they are in secure locations.

The present invention encompasses a method for adapting a challenge for system access. The method comprises the steps of determining a user's location, determining if the user is near a particular location, and determining the challenge for system access such that the challenge is based on whether or not the user is near the particular location.

The present invention additionally encompasses a method for adapting a challenge for system access. The method comprises the steps of determining if a user is in motion and determining a challenge for system access, wherein the challenge is based on whether or not the user is motion.

The present invention additionally encompasses an apparatus comprising a receiver receiving context information and logic circuitry determining a user's location from the context information, determining if the user is near a particular location, and determining the challenge for system access such that the challenge is based on whether or not the user is near the particular location.

The present invention additionally encompasses an apparatus comprising a receiver receiving context information, and logic circuitry determining if a user is in motion from the context information, and determining the challenge for system access such that the challenge is based on whether or not the user is in motion.

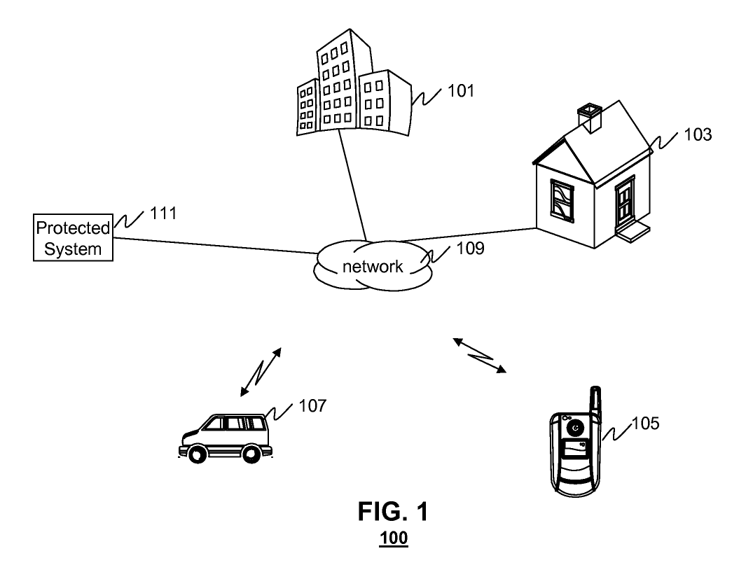

Turning now to the drawings, where like numerals designate like components, FIG. 1 is a block diagram showing user environment 100. As shown, user environment 100 comprises protected system 111, area of restricted access 101, user's residence 103, cellular phone 105, automobile 107, and network 109.

Area of restricted access 101 comprises those buildings or areas where a person is normally not allowed unless they have been specifically granted access. Such areas may include, but are not limited to workplace environments. Area 101 may also comprise points of access (not shown) that are coupled to network 109 and ultimately to protected system 111. These points of access may comprise computer terminals, telephone systems, . . . , etc. used to gain access to protected system 111.

In a similar manner, user residence 103 comprises a premise that a user normally resides. Such areas may include, but are not limited to apartment buildings, condominiums, town houses, houses, . . . , etc. Like area of restricted access, residence 103 may also comprise points of access (not shown) that are coupled to network 109 and ultimately to protected system 111. These points of access may comprise computer terminals, telephone systems, . . . , etc. used to gain access to protected system 111.

Device 105 is shown as comprising a cellular telephone, however, in alternate embodiments device 105 may comprise any mobile wireless device (e.g., PDA, smart phone, personal computer, . . . , etc.) wishing to gain access to protected system 111.

Network 109 is configured to be any type of network that can convey communications between protected system 111 and devices/areas 101-107. The term “network” over which the communication is established may include one or more of the following: a cellular telephone network, a voice over Internet Protocol (VoIP) system, a plain old telephony system (POTS), a digital telephone system, a wired or wireless consumer residence or commercial plant network, a wireless local, national, or international network; or any known type of network used to transmit voice, telephone, data, and/or any other information.

Protected system 111 comprises any system that issues a challenge to a user prior to granting access to the system. Such systems include, but are not limited to computer systems, voice-mail systems, a cellular telephone, . . . , etc. It should be noted that although system 111 is shown existing external to areas 101, 103, 107, and device 105, one of ordinary skill in the art will recognize that protected system 111 may lie within any of these entities, providing access to the entity. For example, system 111 may lie within cellular telephone 105 and grant access to cellular telephone 105.

During operation, protected system 111 will receive a request from a user to gain access to system 111. In response, protected system 111 will issue a challenge (e.g., challenging the user to provide a user name, a password, biometric information, . . . , etc.) via some form of input (keypad entry, voice entry, a token, a vision system, . . . , etc.). If the user successfully answers the challenge, then access is granted to system 111.

As discussed above, there exist many issues with having a single challenge for accessing system 111. For example, keypad entry while driving is difficult. Additionally, it would be much more efficient if the user is presented a challenge that was more secure when the user accesses the system via an “unknown” location as opposed to a location with restricted access. Thus, if the user is accessing from a restricted area, there is a much higher likelihood that the challenged user is the authorized user, and a less-secure challenge may be issued.

In order to address these issues, protected system 111 will identify a user's context and tailor the challenge based on the user's context. In a first embodiment of the present invention, system 111 will determine a user's location, determine if the user's location is within an area of restricted access, and tailor the challenge based on whether or not the user is within an area of restricted access. In this embodiment, a less-restrictive challenge will be issued to the user if they are within an area of restricted access. Thus, for example, if the user is accessing system 111 from area 101, they will be unchallenged, or alternatively they may be challenged to resolve their identity only uniquely among the set of users authorized to be in the area of restricted access. For example, they might be asked to recite a pass phrase or click on pictures in the right sequence instead of typing in a complex password. In a similar manner, if the user is accessing system 111 from their residence 103, or from their automobile 107, they will be challenged with a less restrictive challenge. A more restrictive challenge will be requested when a user is accessing system 111 from an area outside the user's residence or workplace 101.

More restrictive passwords have more restrictive password rules. Thus, for example, a more restrictive password may require the password not contain your first name, or last name, or not begin with a numeric character (the digits 0 through 9), or not match any of your previous passwords, or be at least N characters long, or contain a hyphen (-), underscore (_), dollar ($), pound/hash (#), . . . , etc.

Since most password cracking techniques rely on dictionary based attacks. Brute forcing a password hash takes a significant amount of time and processing power, so to make the process easier, the cracking programs load in a huge list of words, then try variations on the words (e.g. different capitalization, adding numbers at the end, repeating patterns, etc.). So, in essence, more restrictive passwords reducing dictionary words used in the password.

It should be noted that the above technique tailors a challenge based on a user's geographic location, and does not tailor the challenge based on how the user accesses system 111. For example, this geographic location may comprise a determined latitude and longitude.

As is evident, in order to issue challenges as described above, it is necessary to locate the user attempting to gain entry to the system. There exist many techniques for determining a user's location, and that the technique used to determine a user's location is immaterial to this discussion. Some techniques used may comprise utilizing a Global Positioning System (GPS) to determine a user's location, using caller-identification information to determine a place where the call originated from, using standard cellular triangulation techniques to locate a cellular telephone, positioning for a GPS handset, GPS in an automobile, proximity (Bluetooth radio link established between the automobile and a personal device like a handset), an automobile's remote entry/key-FOB, a state of an automobile's door, a weight on the seats (which is used to turn on airbags and seatbelt indicators), . . . , etc.

In a second embodiment of the present invention, the mode of entry for the challenge is modified based on a user's motion and/or their location. For example, if a user is moving, system 111 will require a voice-entry to the challenge instead of a keypad entry. In a similar manner, if the user is found to be accessing system 111 from a particular location (e.g., automobile 107), system 111 may require a voice-entry to the challenge instead of a keypad entry.

As is evident, in order to issue challenges as described above, it is necessary to determine if a user is in motion. As with location, there exist many techniques to determine if a user is in motion. For example, simply locating the user within automobile 107 may cause system 111 to infer that the user is in motion. Variations in GPS locations can also be used to infer motion. In another embodiment radio-frequency (RF) channel variations are analyzed to determine motion. For example, if cellular telephone 105 is in motion, then Doppler-induced channel variations become evident. Based on these Doppler-induced variations, system 111 may infer motion.

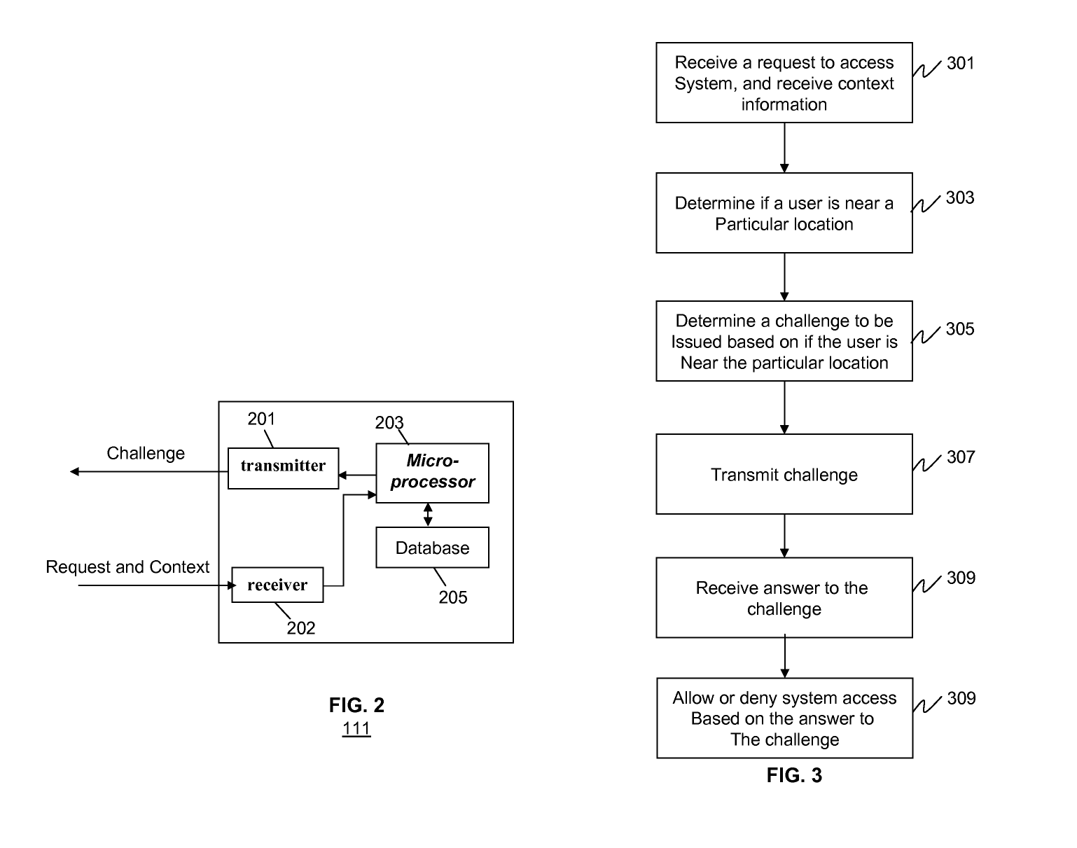

FIG. 2. is a block diagram of system 111 requiring an answer to a challenge to gain access. As shown, system 111 comprises logic circuitry 203, receive circuitry 202, transmit circuitry 201, and database 205. Logic circuitry 203 preferably comprises a microprocessor controller. Logic circuitry 203 serves as means for controlling system 111, and as means for analyzing context information to determine an appropriate challenge. Receive and transmit circuitry 202-201 are common circuitry known in the art for communication utilizing a well known communication protocol, and serve as means for transmitting and receiving messages. Finally, database 205 stores correct answers to challenges so that microprocessor 203 can determine if an answer to a challenge is correct.

Those skilled in the art will appreciate that system 111 is readily enabled using any of a wide variety of available and/or readily configured platforms, including partially or wholly programmable platforms as are known in the art or dedicated purpose platforms as may be desired for some applications.

FIG. 3 is a flow chart showing operation of system 111 in accordance with a first embodiment of the present invention. As discussed above, in the first embodiment of the present invention system 111 determines a user's location, and tailors a challenge based on a user's location. The logic flow begins at step 301 where receiver 202 receives a request to access system 111, along with context information for the user requesting access. As discussed, the user's location may comprise simple geographic coordinates, or may comprise information placing a user at a particular locale (e.g., automobile, home, work, . . . , etc.).

At step 303 microprocessor 203 receives the request and context information and determines if the user is near a particular location. As discussed above, the step of determining if a user is near the particular location may comprise the step of determining if a user is near an area of restricted access. The area of restricted access may comprise buildings or areas where a person is normally not allowed unless they have been specifically granted access. Such buildings or areas may comprise such things as a workplace, a residence, an apartment building, a condominium, a town house, a houses, or an automobile.

Next, at step 305 microprocessor 203 determines a challenge to be issued to the user for system access based on whether or not the user is near the particular location. For example, if a user is near a particular location, a first challenge may be issued to the user, alternatively if the user is not near the particular location, a second challenge may be issued to the user. In one embodiment of the present invention the second challenge is more restrictive than the first challenge. For example no challenge may be issued to the user when the user is near the particular location; otherwise a challenge may be issued to the user.

Once an appropriate challenge is determined by microprocessor 203, the challenge is passed to transmitter 201 where it is transmitted to the user (step 307). Finally, at step 309 the answer to the challenge is received by receiver 202 and microprocessor 203 accesses database 205 in order to determine if the challenge was answered correctly (step 311). System access is either allowed or denied by microprocessor 203 based on whether or not the challenge was answered correctly.

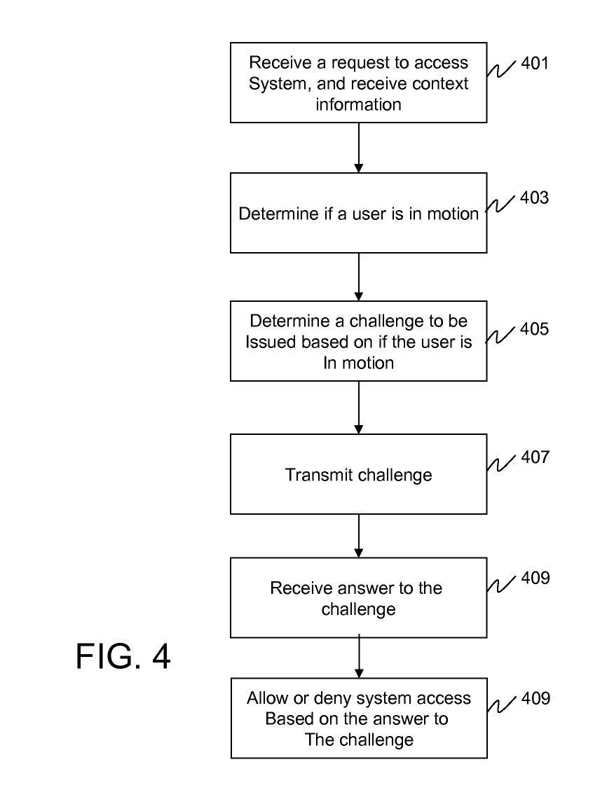

FIG. 4 is a flow chart showing operation of the system 111 in accordance with a second embodiment of the present invention. As discussed above, in the second embodiment of the present invention system 111 determines if a user is in motion and tailors a challenge based on a user's motion.

The logic flow begins at step 401 where receiver 202 receives a request to access system 111, along with context information for the user requesting access. At step 403 microprocessor 203 receives the request and context information and determines if the user is in motion. As discussed above, the step of determining if the user is in motion may comprise inferring the user is in motion if the user is determined to be in an automobile, analyzing channel variations do determine if the user is in motion, or analyzing GPS information to infer the user is in motion.

At step 405 microprocessor 203 determines an appropriate challenge. For example, if a user is in motion, a first challenge may be issued to the user, alternatively, if the user is not in motion, a second challenge may be issued to the user. As discussed above, the second challenge may be more restrictive than the first challenge, or the first challenge may be a voiced challenge (i.e., input the answer to the challenge via a the user's voice) and the second challenge may be an unvoiced challenge.

Once an appropriate challenge is determined by microprocessor 203, the challenge is passed to transmitter 201 where it is transmitted to the user (step 407). Finally, at step 409 the answered challenge is received by receiver 202 and microprocessor 203 accesses database 205 in order to determine if the challenge was answered correctly (step 411). System access is either allowed or denied by microprocessor 203 based on whether or not the challenge was answered correctly.

While the invention has been particularly shown and described with reference to a particular embodiment, it will be understood by those skilled in the art that various changes in form and details may be made therein without departing from the spirit and scope of the invention. It is intended that such changes come within the scope of the following claims:

1. A method for adapting a challenge for system access, the method comprising the steps of:
determining a user's location;
determining if the user is near a particular location; and
determining the challenge for system access such that the challenge is based on whether or not the user is near the particular location.

2. The method of claim 1 further comprising the steps of:
receiving an answer to the challenge; and
allowing or denying system access based on the answer to the challenge.

3. The method of claim 1 wherein the step of determining if a user is near the particular location comprises the step of determining if the user is near an area of restricted access.

4. The method of claim 3 wherein the area of restricted access comprises buildings or areas where a person is normally not allowed unless they have been specifically granted access.

5. The method of claim 3 wherein the area of restricted access is taken from the group consisting of: a workplace, a residence, an apartment building, a condominium, a town house, a house, and an automobile.

6. The method of claim 1 wherein the step of determining the challenge for system access comprises the steps of:
determining a first challenge that will be issued to the user when the user is near the particular location; otherwise
determining a second challenge that will be issued to the user.

7. The method of claim 6 wherein the second challenge is more restrictive than the first challenge.

8. The method of claim 1 wherein the step of determining the challenge for system access comprises the steps of:
determining no challenge will be issued to the user when the user is near the particular location; otherwise
determining a challenge that will be issued to the user.

9. The method of claim 1 wherein the particular location comprises simple geographic coordinates or comprise information placing a user at a particular locale.

10. A method for adapting a challenge for system access, the method comprising the steps of:
determining if a user is in motion; and
determining a challenge for system access, wherein the challenge is based on whether or not the user is motion.

11. The method of claim 10 further comprising the steps of:
receiving an answer to the challenge; and
allowing or denying system access based on the answer to the challenge.

12. The method of claim 10 wherein the step of determining if the user is in motion comprises the step of inferring the user is in motion if the user is determined to be in an automobile.

13. The method of claim 10 wherein the step of determining the challenge for system access comprises the steps of:
determining a first challenge that will be issued to the user when the user is in motion; otherwise
determining a second challenge that will be issued to the user.

14. The method of claim 13 wherein the second challenge is more restrictive than the first challenge.

15. The method of claim 13 wherein the first challenge is a voiced challenge and the second challenge is an unvoiced challenge.

16. An apparatus comprising:
a receiver receiving context information;
logic circuitry determining a user's location from the context information, determining if the user is near a particular location, and determining the challenge for system access such that the challenge is based on whether or not the user is near the particular location.

17. The apparatus of claim 16 further comprising:
a receiver receiving an answer to the challenge; and
wherein logic circuitry allows or denies system access based on the answer to the challenge.

18. An apparatus comprising:
a receiver receiving context information;
logic circuitry determining if a user is in motion from the context information, and determining the challenge for system access such that the challenge is based on whether or not the user is in motion.

19. The apparatus of claim 16 further comprising:
a receiver receiving an answer to the challenge; and
wherein logic circuitry allows or denies system access based on the answer to the challenge.
